(19) United States
(12) Patent Application Publication
(10) Pub. No.: US 2022/0335694 A1
(43) Pub. Date: Oct. 20, 2022

(54) ANCHORING A SCENE DESCRIPTION TO A USER ENVIRONMENT FOR STREAMING IMMERSIVE MEDIA CONTENT

(71) Applicant: QUALCOMM Incorporated, San Diego, CA (US)

(72) Inventors: Imed Bouazizi, Frisco, TX (US); Thomas Stockhammer, Bergen (DE)

(21) Appl. No.: 17/659,760

(22) Filed: Apr. 19, 2022

Related U.S. Application Data
(60) Provisional application No. 63/177,261, filed on Apr. 20, 2021.

(51) Int. Cl. G06T 19/00; G06V 20/20

(52) U.S. Cl. CPC G06T 19/006; G06V 20/20; G06T 2219/2016; G06T 2219/2004

(57) ABSTRACT

An example device for presenting media data includes a memory configured to store media data defining one or more virtual objects in a virtual scene; and one or more processors implemented in circuitry and configured to: receive a scene description of a bitstream including the data describing the one or more virtual objects in the virtual scene and a scene anchor, the scene anchor representing a correspondence between the virtual scene and a real-world presentation environment; determine the correspondence between the virtual scene and the real-world presentation environment using the scene anchor; and present the one or more virtual objects at locations within the real-world presentation environment according to the determined correspondence.

This application claims the benefit of U.S. Provisional Application No. 63/177,261, filed Apr. 20, 2021, the entire contents of which are hereby incorporated by reference.

### TECHNICAL FIELD

This disclosure relates to storage and transport of media data, especially for immersive media content.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for streaming and presenting immersive media content, e.g., for augmented reality (AR), virtual reality (VR), or mixed reality (MR) content. Such content may generally be referred to as extended reality (XR) content. In general, XR content may include a virtual scene including one or more virtual objects. The virtual scene may be presented to a user as three-dimensional (3D) and navigable media content. For example, the user may be able to navigate the virtual scene using controllers and/or real-world movement. In order to allow for proper movement in a real-world presentation environment, as well as to ensure that virtual objects are appropriately presented, this disclosure describes techniques for anchoring the virtual scene to the real-world presentation environment. For example, one or more real-world anchor points may be identified and used to anchor the virtual scene to the real-world presentation environment. These anchor points may be defined in a scene description, which may include a scene graph.

In one example, a method of presenting media data includes receiving a scene description of a bitstream, the scene description including data describing a scene anchor and one or more virtual objects in a virtual scene, the scene anchor representing a correspondence between the virtual scene and a real-world presentation environment; determining the correspondence between the virtual scene and the real-world presentation environment using the scene anchor; and presenting the one or more virtual objects at locations within the real-world presentation environment according to the determined correspondence.

In another example, a device for presenting media data includes a memory configured to store media data defining one or more virtual objects in a virtual scene; and one or more processors implemented in circuitry and configured to: receive a scene description of a bitstream, the scene description including data describing a scene anchor and one or more virtual objects in a virtual scene, the scene anchor representing a correspondence between the virtual scene and a real-world presentation environment; determine the correspondence between the virtual scene and the real-world presentation environment using the scene anchor; and present the one or more virtual objects at locations within the real-world presentation environment according to the determined correspondence.

In another example, a computer-readable storage medium has stored thereon instructions that, when executed, cause a processor to receive a scene description of a bitstream, the scene description including data describing a scene anchor and one or more virtual objects in a virtual scene, the scene anchor representing a correspondence between the virtual scene and a real-world presentation environment; determine the correspondence between the virtual scene and the real-world presentation environment using the scene anchor; and present the one or more virtual objects at locations within the real-world presentation environment according to the determined correspondence.

In another example, a device for presenting media data includes means for receiving a scene description of a bitstream, the scene description including data describing a scene anchor and one or more virtual objects in a virtual scene, the scene anchor representing a correspondence between the virtual scene and a real-world presentation environment; means for determining the correspondence between the virtual scene and the real-world presentation environment using the scene anchor; and means for presenting the one or more virtual objects at locations within the real-world presentation environment according to the determined correspondence.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating an example set of components of the retrieval unit of FIG. 1 in greater detail.

FIG. 3 is a conceptual diagram illustrating elements of example multimedia content.

FIG. 4 is a block diagram illustrating elements of an example video file, which may correspond to a segment of a representation.

FIG. 5 is a graph illustrating an example Graphics Language Transmission Format (glTF) scene graph structure.

FIG. 6 is a block diagram illustrating an example MPEG-I architecture, including important interfaces between various components.

FIG. 7 is a conceptual diagram illustrating an example circular buffer.

FIG. 8 is a block diagram illustrating an example MPEG-I Scene Description architecture.

FIG. 9 is a conceptual diagram illustrating an example anchor XR space indicated by a scene description.

FIG. 10 is a block diagram illustrating another example client device 300 that may perform the techniques of this disclosure.

FIG. 11 is a flowchart illustrating an example method according to the techniques of this disclosure.

### DETAILED DESCRIPTION

In general, this disclosure describes techniques for streaming immersive media content, e.g., for extended reality (XR) content, such as augmented reality (AR), mixed reality (MR), or virtual reality (VR) content. In particular, this disclosure describes techniques for signaling correspondence between a virtual environment and a real-world presentation environment in which the virtual environment is to be presented. In this manner, a client device can orient and/or scale the virtual environment to fit the real-world presentation environment, e.g., to ensure boundaries of the virtual environment do not exceed boundaries of the real-world presentation environment. Thus, the client device may avoid presenting the virtual environment in a manner that may cause boundaries of the virtual environment to exceed the boundaries of the real-world presentation environment, which may help avoid collisions between a user and real-world objects, such as walls, chairs, tables, and the like. Similarly, these techniques may ensure that the user is able to take advantage of larger real-world presentation environments when more real-world room is available.

These techniques may be beneficial in the context of streamed immersive media content, in that a server device that sends the immersive media content need to be provided with details representing multiple different real-world presentation environments for each recipient of the immersive media content. Instead, these techniques allow each respective client device to determine appropriate real-world anchor points that correspond to anchor points as defined in the scene description. In this manner, excess processing by the server may be avoided, while still allowing for each individual presentation of the immersive media content to conform to the corresponding real-world presentation environment in which the immersive media content is presented.

The techniques of this disclosure may be applied to video files conforming to video data encapsulated according to any of ISO base media file format, Scalable Video Coding (SVC) file format, Advanced Video Coding (AVC) file format, Third Generation Partnership Project (3GPP) file format, and/or Multiview Video Coding (MVC) file format, or other similar video file formats.

In HTTP streaming, frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

In the example of streaming 3GPP data using HTTP streaming, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in a Media Presentation Description (MPD) data structure. A media presentation may correspond to a structured collection of data that is accessible to an HTTP streaming client device. The HTTP streaming client device may request and download media data information to present a streaming service to a user of the client device. A media presentation may be described in the MPD data structure, which may include updates of the MPD.

A media presentation may contain a sequence of one or more Periods. Each period may extend until the start of the next Period, or until the end of the media presentation, in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

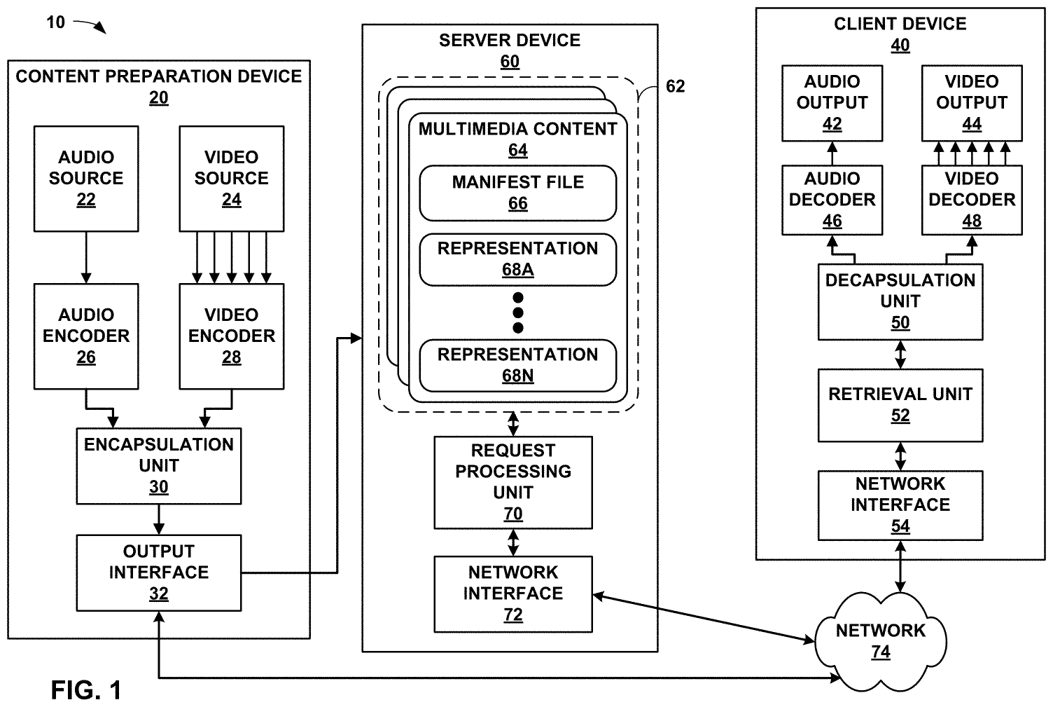

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/AVC and the upcoming High Efficiency Video Coding (HEVC) standard, define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive blocks, such as macroblocks (MBs), and whether a B-block can have sub-block partitions less than 8×8 pixels. In this manner, a decoder may determine whether the decoder is capable of properly decoding the bitstream.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. For example, request processing unit 70 may implement hypertext transfer protocol (HTTP) version 1.1, as described in RFC 2616, “Hypertext Transfer Protocol—HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally or alternatively, request processing unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bitrate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

As discussed in greater detail below, client device 40 may be configured to perform the various techniques of this disclosure alone or in any combination. In general, retrieval unit 52 may be configured to retrieve a bitstream including media data (e.g., scene data), as discussed above, as well as a scene description. The scene description may include anchor point data representing a correspondence between a virtual scene represented by the media data and a real-world presentation environment. Client device 40 may be configured to anchor the virtual scene to the real-world presentation environment using the anchor point data, and also transform the virtual scene as needed, e.g., through rotation, translation, and/or scaling.

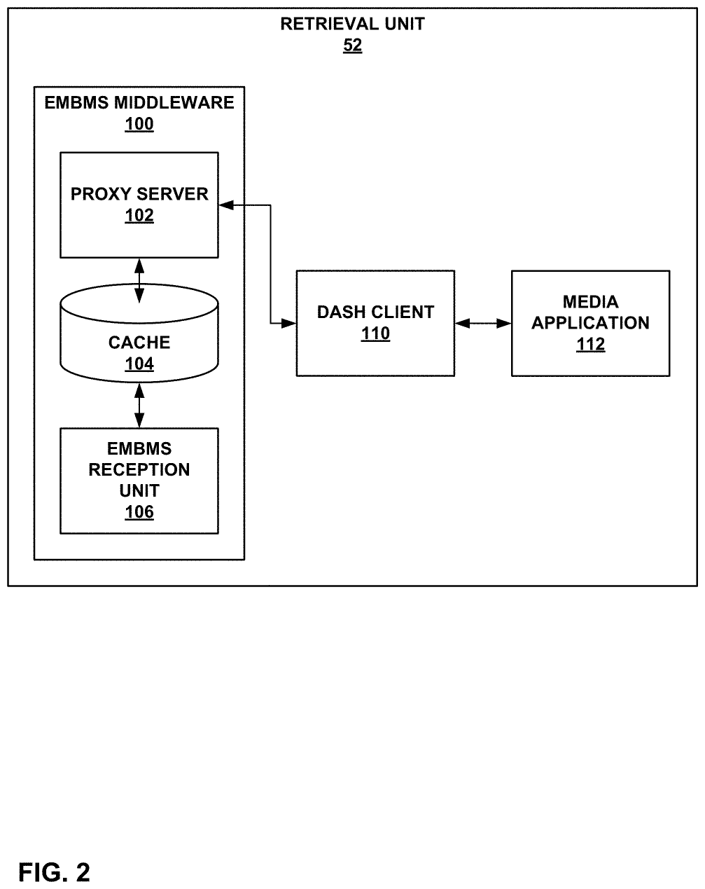

FIG. 2 is a block diagram illustrating an example set of components of retrieval unit 52 of FIG. 1 in greater detail. In this example, retrieval unit 52 includes eMBMS middleware unit 100, DASH client 110, and media application 112.

In this example, eMBMS middleware unit 100 further includes eMBMS reception unit 106, cache 104, and proxy server unit 102. In this example, eMBMS reception unit 106 is configured to receive data via eMBMS, e.g., according to File Delivery over Unidirectional Transport (FLUTE), described in T. Paila et al., “FLUTE—File Delivery over Unidirectional Transport,” Network Working Group, RFC 6726, November 2012, available at tools.ietf.org/html/rfc6726. That is, eMBMS reception unit 106 may receive files via broadcast from, e.g., server device 60, which may act as a broadcast/multicast service center (BM-SC).

As eMBMS middleware unit 100 receives data for files, eMBMS middleware unit may store the received data in cache 104. Cache 104 may comprise a computer-readable storage medium, such as flash memory, a hard disk, RAM, or any other suitable storage medium.

Proxy server unit 102 may act as a server for DASH client 110. For example, proxy server unit 102 may provide a MPD file or other manifest file to DASH client 110. Proxy server unit 102 may advertise availability times for segments in the MPD file, as well as hyperlinks from which the segments can be retrieved. These hyperlinks may include a localhost address prefix corresponding to client device 40 (e.g., 127.0.0.1 for IPv4). In this manner, DASH client 110 may request segments from proxy server unit 102 using HTTP GET or partial GET requests. For example, for a segment available from link http://127.0.0.1/rep1/seg3, DASH client 110 may construct an HTTP GET request that includes a request for http://127.0.0.1/rep1/seg3, and submit the request to proxy server unit 102. Proxy server unit 102 may retrieve requested data from cache 104 and provide the data to DASH client 110 in response to such requests.

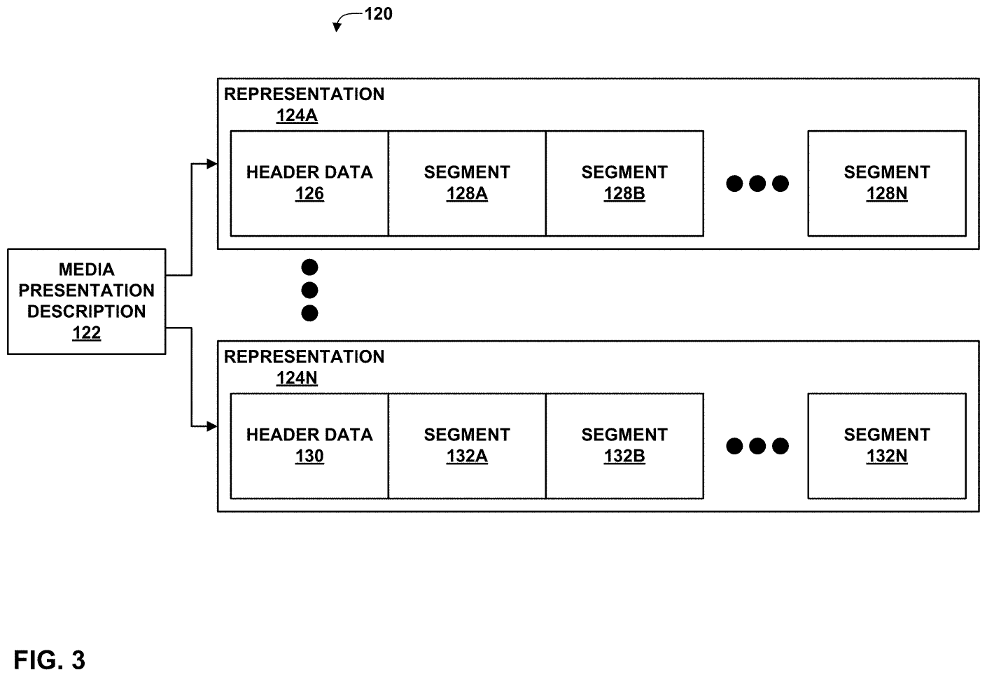

FIG. 3 is a conceptual diagram illustrating elements of example multimedia content 120. Multimedia content 120 may correspond to multimedia content 64 (FIG. 1), or another multimedia content stored in storage medium 62. In the example of FIG. 3, multimedia content 120 includes media presentation description (MPD) 122 and a plurality of representations 124A-124N (representations 124). Representation 124A includes optional header data 126 and segments 128A-128N (segments 128), while representation 124N includes optional header data 130 and segments 132A-132N (segments 132). The letter N is used to designate the last movie fragment in each of representations 124 as a matter of convenience. In some examples, there may be different numbers of movie fragments between representations 124.

MPD 122 may comprise a data structure separate from representations 124. MPD 122 may correspond to manifest file 66 of FIG. 1. Likewise, representations 124 may correspond to representations 68 of FIG. 1. In general, MPD 122 may include data that generally describes characteristics of representations 124, such as coding and rendering characteristics, adaptation sets, a profile to which MPD 122 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 126, when present, may describe characteristics of segments 128, e.g., temporal locations of random access points (RAPs, also referred to as stream access points (SAPs)), which of segments 128 includes random access points, byte offsets to random access points within segments 128, uniform resource locators (URLs) of segments 128, or other aspects of segments 128. Header data 130, when present, may describe similar characteristics for segments 132. Additionally or alternatively, such characteristics may be fully included within MPD 122.

Segments 128, 132 include one or more coded video samples, each of which may include frames or slices of video data. Each of the coded video samples of segments 128 may have similar characteristics, e.g., height, width, and bandwidth requirements. Such characteristics may be described by data of MPD 122, though such data is not illustrated in the example of FIG. 3. MPD 122 may include characteristics as described by the 3GPP Specification, with the addition of any or all of the signaled information described in this disclosure.

Each of segments 128, 132 may be associated with a unique uniform resource locator (URL). Thus, each of segments 128, 132 may be independently retrievable using a streaming network protocol, such as DASH. In this manner, a destination device, such as client device 40, may use an HTTP GET request to retrieve segments 128 or 132. In some examples, client device 40 may use HTTP partial GET requests to retrieve specific byte ranges of segments 128 or 132.

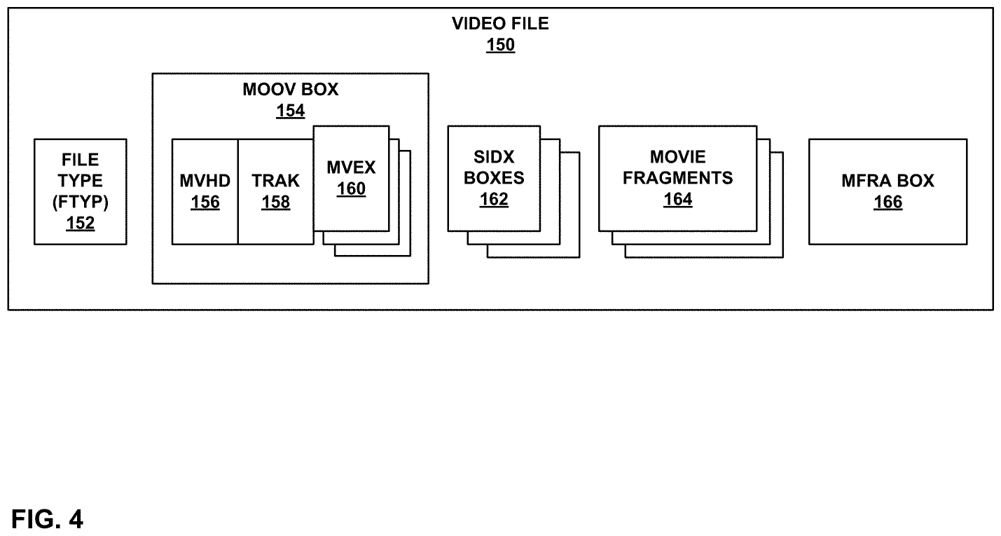

FIG. 4 is a block diagram illustrating elements of an example video file 150, which may correspond to a segment of a representation, such as one of segments 128, 132 of FIG. 3. Each of segments 128, 132 may include data that conforms substantially to the arrangement of data illustrated in the example of FIG. 4. Video file 150 may be said to encapsulate a segment. As described above, video files in accordance with the ISO base media file format and extensions thereof store data in a series of objects, referred to as “boxes.” In the example of FIG. 4, video file 150 includes file type (FTYP) box 152, movie (MOOV) box 154, segment index (sidx) boxes 162, movie fragment (MOOF) boxes 164, and movie fragment random access (MFRA) box 166. Although FIG. 4 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

In some examples, a Segment, such as video file 150, may include an MPD update box (not shown) before FTYP box 152. The MPD update box may include information indicating that an MPD corresponding to a representation including video file 150 is to be updated, along with information for updating the MPD. For example, the MPD update box may provide a URI or URL for a resource to be used to update the MPD. As another example, the MPD update box may include data for updating the MPD. In some examples, the MPD update box may immediately follow a segment type (STYP) box (not shown) of video file 150, where the STYP box may define a segment type for video file 150.

MOOV box 154, in the example of FIG. 4, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 4). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

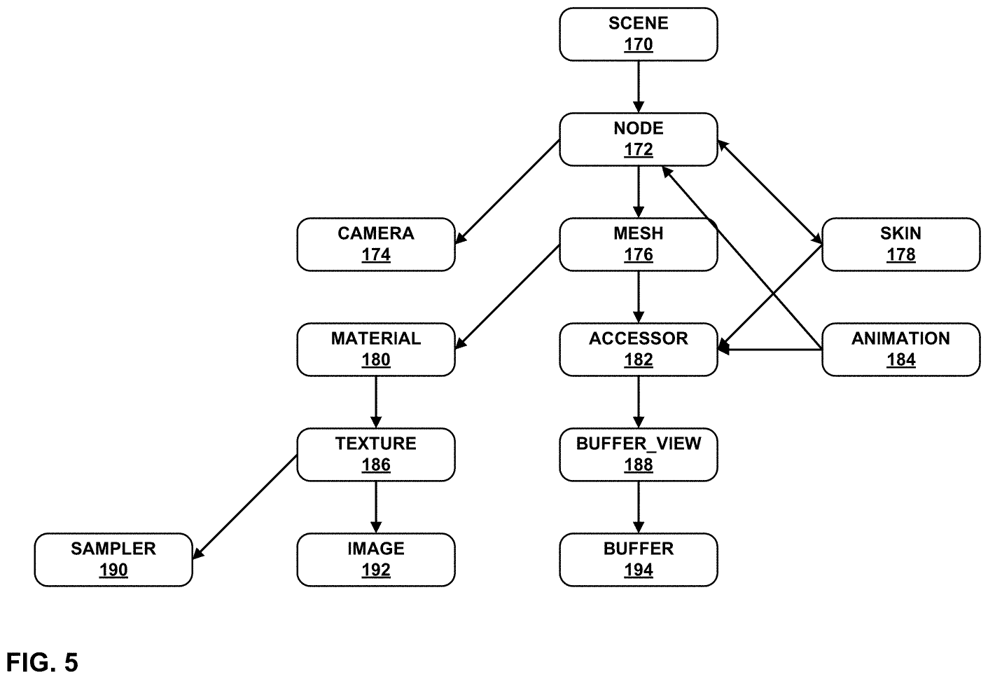

FIG. 5 is a graph illustrating an example Graphics Language Transmission Format (glTF) scene graph structure. One technology for enabling immersive three-dimensional (3D) user experiences is a scene description. A scene description may be used to describe the composition of a 3D scene, where the scene description includes data referencing and positioning various two-dimensional (2D) and 3D assets in the scene. The information provided in the scene description may then be used by a presentation engine to render the 3D scene properly, using techniques like Physically-Based Rendering (PBR) that produce realistic scenes.

A scene description usually includes a scene graph, which is a directed acyclic graph, typically a plain tree-structure, that represents an object-based hierarchy of the geometry of a scene. The leaf nodes of the graph represent geometric primitives such as images, textures, or media data buffers. Each node in the graph holds pointers to its children. The child nodes can, among others, be a group of other nodes, a geometry element, a transformation matrix, accessors to media data buffers, camera information for the rendering, or the like.

Spatial transformations are represented as nodes of the graph and represented by a transformation matrix. Typical usage of transform nodes is to describe rotation, translation or scaling of the objects in its child nodes. Scene graph also supports animations nodes that allow to change animation properties over time, hence describing dynamic content.

This structure of scene graphs has the advantage of reduced processing complexity, e.g., while traversing the graph for rendering. An example operation that is simplified by the graph representation is the culling operation, where branches of the graph are dropped from processing, if deemed that the parent node's space is not visible or relevant (level of detail culling) to the rendering of the current view frustum.

While there are many proprietary solutions for scene description (typically at the heart of game engines, VFX design tools, or AR/VR authoring tools), several solutions have also been standardized. In particular, in 2001, Virtual Reality Modeling Language (VRML), which uses an XML syntax, was the first scene description solution to be standardized for WEB usages. Later on, OpenSceneGraph, an open source project using OpenGL that was released in 2005, has been used as a component in several computer games and rendering platforms such as Delta3D or FlightGear. In 2010, X3D, standardized by ISO/IEC, became the successor of VRML. X3D introduced binary formats and JSON format for the scene graph description and featured new capabilities such as multi-texture rendering, shading, real-time environment lightning, and culling. In 2015, the Khronos Group, which also manages OpenGL, released the Graphics Library Transmission Format (glTF). glTF is a scene description format, based on a JSON format, intended to be efficient and interoperable as a common description format for 3D content tools and services.

A typical glTF scene graph, such as that shown in FIG. 5, is a tree of nodes describing content properties, access to content data, possible dynamic animations, and parameters for rendering. In the example of FIG. 5, the scene graph structure includes scene node 170 that has a child node 172. Node 172 has child camera node 174, mesh node 176, and skin node 178. Mesh node has child material node 180 and accessor node 182. Animation node 184 is also a parent noted to node 172 and accessor node 182, and skin node 178 has an edge to accessor node 182. Accessor node 182 has child buffer_view node 188, which itself has child buffer node 194. Material node 180 has child texture node 186. Texture node 186 has child sampler node 190 and image node 192.

Typically, camera node 174 includes data describing the view from which rendering shall be made. 3D objects may be described in mesh sub-nodes, such as mesh node 176, whose child nodes provide information on how to access the media data through buffers and texture information (e.g., accessor node 182, buffer_view node 188, buffer node 194, material node 180, texture node 186, sampler node 190, and image node 192). Animation nodes, such as animation node 184, may include data describing dynamic changes of 3D objects over time.

glTF 2.0 provides a solid and efficient baseline for exchangeable and interoperable scene descriptions. However, glTF 2.0 has traditionally been focused on static scenes and assets, which makes it unfit to address the requirements and needs of dynamic and rich 3D scenes in immersive environments.

Certain gaps in glTF 2.0 include:
No support for timed media like video and moving meshes and point clouds.
No support for audio.
Limited support for interactions with the scene and the assets in the scene.
No support for local and real-time media, which are crucial for example for AR experiences.

MPEG has decided to leverage the extension mechanism that glTF 2.0 offers, to develop its solution for immersive multimedia after carefully evaluating different alternatives, including home grown old scene graph solutions and the possibility of defining a new one from scratch.

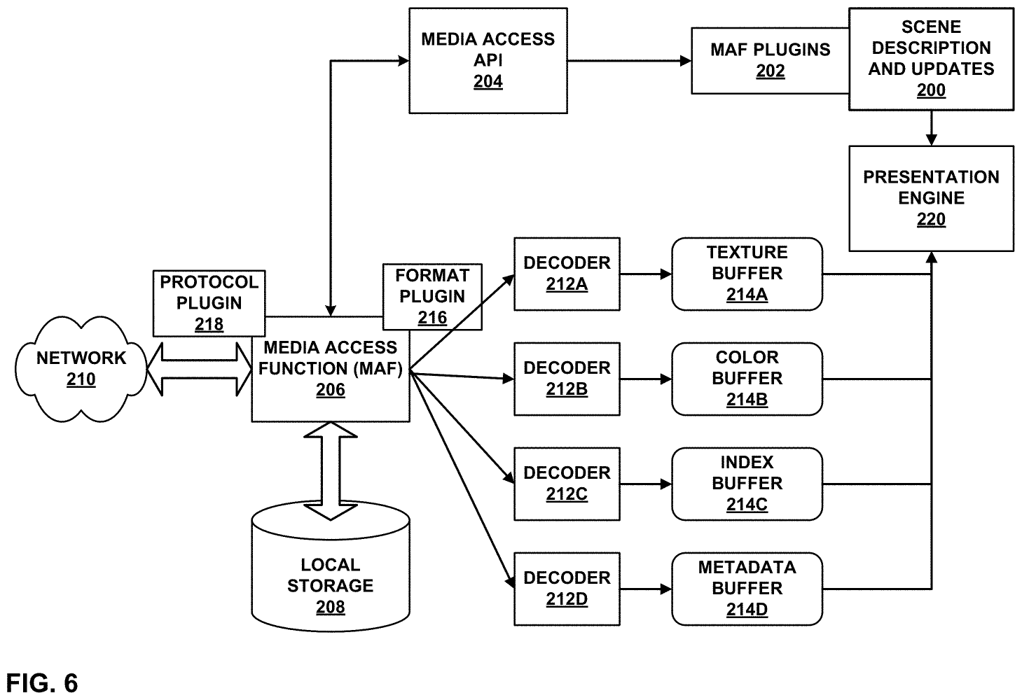

FIG. 6 is a block diagram illustrating an example MPEG-I architecture, including important interfaces between various components. In this example, the MPEG-I architecture includes scene description and updates 200, media access function (MAF) 206, format plugin 216, protocol plugin 218, media access application programming interface (API) 204, MAF plugins 202, presentation engine 220, network 210, local storage 208, decoders 212A-212D (decoders 212), texture buffer 214A, color buffer 214B, index buffer 214C, and metadata buffer 214D (buffers 214). Scene description and updates 200 may correspond to the scene graph of FIG. 5.

MPEG developed an architecture for MPEG-I to guide the work on the scene description, which serves as the entry point for consumption of an immersive media presentation. The design focuses mainly on buffers (e.g., texture buffer 214A, color buffer 214B, index buffer 214C, and metadata buffer 214D) as means for data exchange throughout the media access and rendering pipeline. It also defines media access API 204 to request media that is referenced by scene description and updates 200, which will be made accessible through buffers 214. This design aligns nicely with glTF 2.0 principles and integrates well with a video decoding interface.

In order to provide access to timed media and metadata in a scene, a glTF extension has been specified to define timed accessors (MPEG_accessor_timed extension). An accessor in glTF defines the types and layout of the data as stored in a buffer that is viewed through a bufferView. When timed data is read from a buffer, the data in the buffer is expected to change dynamically with time. The buffer element is extended to add support for a circular buffer that is used with timed data. According to the MPEG extension, a scene that contains timed media and/or metadata shall use the timed accessor extension to access the data. The timed accessor is an extension to regular accessors to indicate that the underlying data buffer is dynamic.

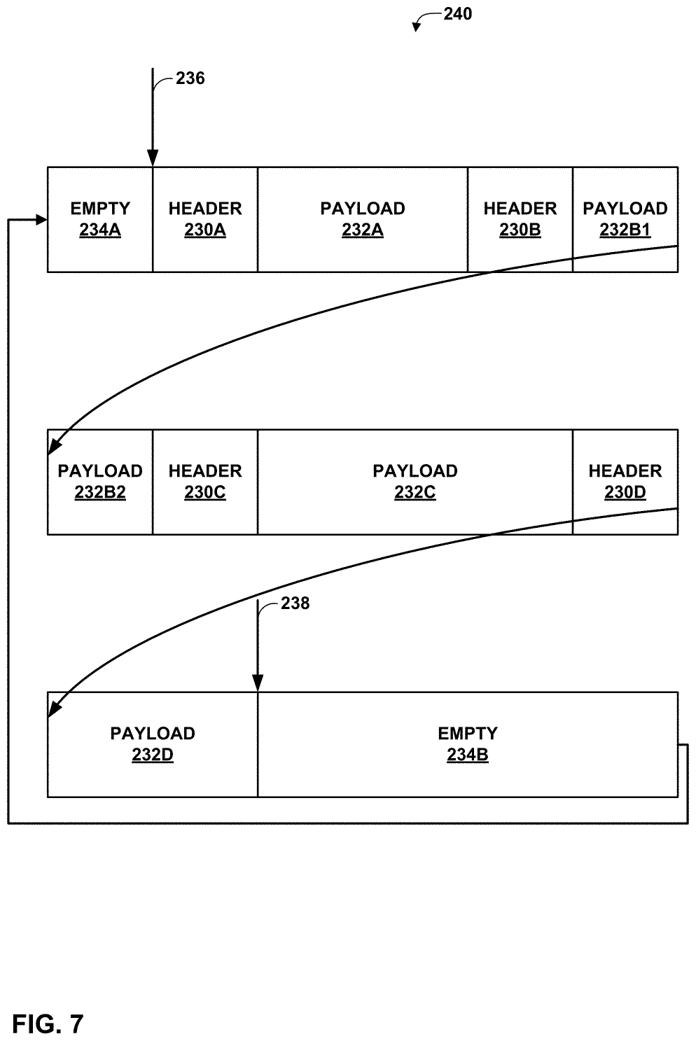

FIG. 7 is a conceptual diagram illustrating an example circular buffer. In order to support timed data access, the buffer element has been extended by MPEG to provide circular buffer functionality. The extension is named “MPEG_circular_buffer” and may be included as part of “buffers” structures. Buffers that provide access to timed data may include the “MPEG_circular_buffer” extension.

In the example of FIG. 7, circular buffer 240 includes empty data 234A, 234B (which may correspond to portions of circular buffer 240 that do not include usable media data), as well as decoded media frames including respective headers 230A-230D and payloads 232A-232D. Although four frames are shown in this example, in general, circular buffer 240 may store any arbitrary number of frames, according to an amount of memory allocated to circular buffer 240 and a size of the frames.

Client device 40 of FIG. 1 may maintain read pointer 236 and write pointer 238. In general, read pointer 236 identifies a starting point of a next media frame to be read (in this case, the frame including header 230A and payload 232A), while write pointer 238 represents a portion of circular buffer 240 at which a subsequent frame can be written. As discussed above, client device 40 may manage circular buffer 240 in such a manner that read pointer 236 does not pass write pointer 238, and also to prevent write pointer 238 from overtaking read pointer 236, to avoid buffer overflow and underflow.

In this example, client device 40 may allocate memory for circular buffer 240 based on a number of frames to be stored, dimensions of each frame, and the sample format of every texel of the frame. Multiple frames may be used to swap the buffers and ensure smooth access to the buffer. An accessor of client device 40 may maintain both read pointer 236 and write pointer 238 as shown. The frames are read at read pointer 236 for rendering. New incoming frames from the media decoder are inserted at write pointer 238. Prior data in that frame may be overwritten and the frame buffer may be resized accordingly. Client device 40 may store values for read pointer 236 and write pointer 238 as offsets into the buffer.

The renderer of client device 40 may ensure that Timestamp(write_pointer)>Timestamp(read_pointer). When overwriting a frame in the buffer with a new decoded video frame, the renderer may ensure that the read_pointer is moved to the frame with the oldest timestamp. This may result in a frame drop, but may also ensure that no concurrent access to the same frame in the buffer is performed.

An MPEG media extension, identified by MPEG_media, provides an array of MPEG media items used in the scene.

An MPEG video texture extension, identified by “MPEG_video_texture,” provides the possibility to link a glTF texture object to media and its respective track listed by an MPEG_media object. The MPEG video texture extension also provides a reference to a timed accessor, using timedAccessor object, where the decoded timed texture will be made available.

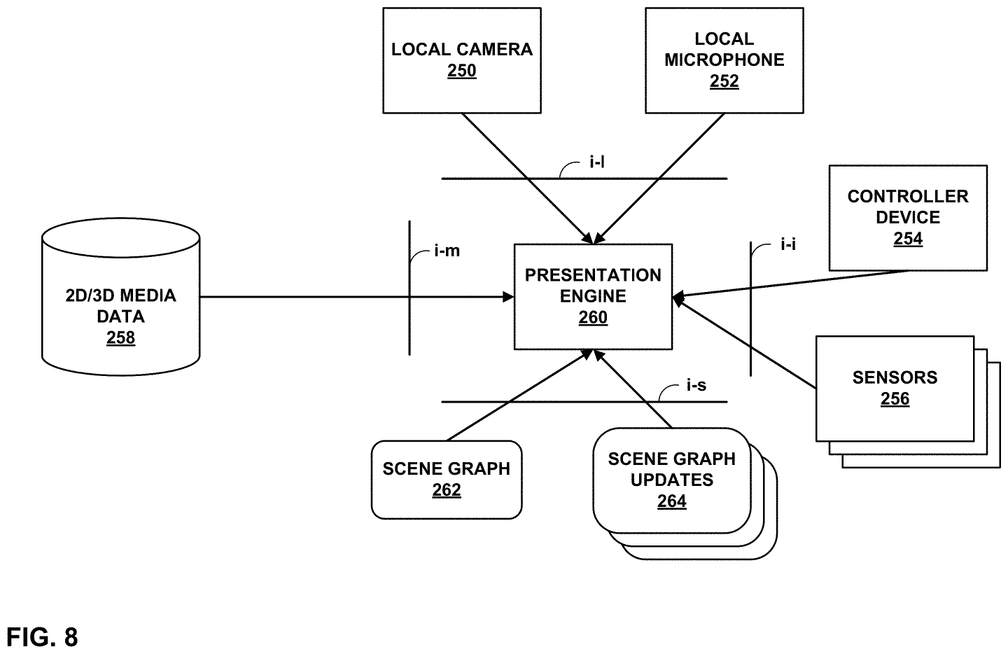

FIG. 8 is a block diagram illustrating an example MPEG-I Scene Description architecture. The MPEG-I Scene Description solution is designed to describe scenes that mix media from different input modalities. The interaction with these different modalities is assured through dedicated interfaces to the presentation engine that consumes the scene description. The interaction with the local real-world of the viewer is performed through the i−1 and i-i interfaces. These interfaces can leverage existing APIs such as OpenXR.

In this example, the MPEG-I Scene Description architecture includes local camera 250, local microphone 252, controller device 254, sensors 256, scene graph 262, scene graph updates 264, 2D/3D media data 258, and presentation engine 260. Local camera 250 may be used to capture images of local, real-world objects, which may be used as anchor points for a virtual scene. Local microphone 252 may be used to capture user speech. Controller device 254 may be a game controller device including one or more buttons, track pads, or the like for receiving user input. Sensors 256 may include gyroscopes, motion sensors, light sensors, or other types of sensors for detecting user posture, virtual camera orientation, user location, or the like. 2D/3D media data 258 may include data for rendering a virtual scene, e.g., one or more virtual objects, including walls, floor, ceiling, chairs, tables, or any other virtual object, as well as locations of the objects within the virtual scene. Scene graph 262 and scene graph updates 264 may correspond to scene description and updates 200 of FIG. 6 and the scene graph of FIG. 5.

OpenXR is an application programming interface (API) for developing XR applications that address a wide range of XR devices. XR refers to a mix of real and virtual world environments that are generated by computers through interactions by humans. XR includes technologies such as virtual reality (VR), augmented reality (AR), and mixed reality (MR). OpenXR is the interface between an application and XR runtime. The runtime handles functionality such as frame composition, user-triggered actions, and tracking information.

OpenXR is designed to be a layered API, which means that a user or application may insert API layers between the application and the runtime implementation. These API layers provide additional functionality by intercepting OpenXR functions from the layer above and then performing different operations than would otherwise be performed without the layer. In the simplest cases, the layer simply calls the next layer down with the same arguments, but a more complex layer may implement API functionality that is not present in the layers or runtime below it. This mechanism is essentially an architected “function shimming” or “intercept” feature that is designed into OpenXR and meant to replace more informal methods of “hooking” API calls.

Applications can determine the API layers that are available to them by calling the xrEnumerateApiLayerProperties function to obtain a list of available API layers. Applications then can select the desired API layers from this list and provide them to the xrCreateInstance function when creating an instance.

API layers may implement OpenXR functions that may or may not be supported by the underlying runtime. In order to expose these new features, the API layer must expose this functionality in the form of an OpenXR extension. It must not expose new OpenXR functions without an associated extension.

An OpenXR instance is an object that allows an OpenXR application to communicate with an OpenXR runtime. The application accomplishes this communication by calling xrCreateInstance and receiving a handle to the resulting XrInstance object.

The XrInstance object stores and tracks OpenXR-related application state, without storing any such state in the application's global address space. This allows the application to create multiple instances as well as safely encapsulate the application's OpenXR state since this object is opaque to the application. OpenXR runtimes may limit the number of simultaneous XrInstance objects that may be created and used, but they must support the creation and usage of at least one XrInstance object per process.

Spaces are represented by XrSpace handles, which the application creates and then uses in API calls. Whenever an application calls a function that returns coordinates, it provides an XrSpace to specify the frame of reference in which those coordinates will be expressed. Similarly, when providing coordinates to a function, the application specifies which XrSpace the runtime should use to interpret those coordinates.

OpenXR defines a set of well-known reference spaces that applications use to bootstrap their spatial reasoning. These reference spaces are: VIEW, LOCAL, and STAGE. Each reference space has a well-defined meaning, which establishes where its origin is positioned and how its axes are oriented.

Runtimes whose tracking systems improve their understanding of the world over time may track spaces independently. For example, even though a LOCAL space and a STAGE space each map their origin to a static position in the world, a runtime with an inside-out tracking system may introduce slight adjustments to the origin of each space on a continuous basis to keep each origin in place.

Beyond well-known reference spaces, runtimes expose other independently-tracked spaces, such as a pose action space that tracks the pose of a motion controller over time.

The scene description, including scene graph 262 and scene graph updates 264, as discussed above, acts as the entry point in a set of data for consuming immersive media data. The scene description describes all virtual objects of the scene and their spatial and temporal relationships. Currently, the scene description (and no other element) describes relationships between virtual objects of a scene and objects in the real-world. In order to support AR and MR applications, however, this disclosure recognizes the necessity of describing such relationships between virtual objects and real-world objects.

More particularly, this disclosure describes techniques for anchoring a scene to real-world spaces. In one example, the anchors used may be mapped to OpenXR spaces.

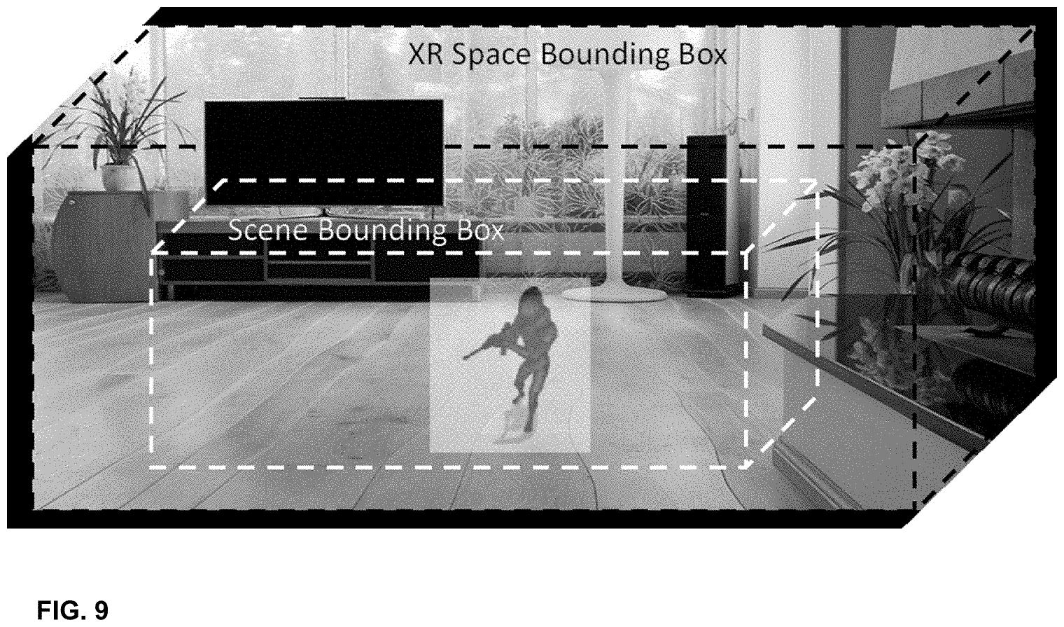

FIG. 9 is a conceptual diagram illustrating an example anchor XR space indicated by a scene description. According to the techniques of this disclosure, a scene description node may contain a reference to an XR space, which indicates that the scene is anchored to that space. The anchor XR space may be a reference space, e.g., local, view, or stage. Alternatively, the anchor XR space may be an application-defined space that is setup at runtime based on application or user input. The scene description indicates the type of the anchor XR space. If the anchor space is an application-defined space, the scene description may provide some constraints on the XR space that the application should enforce.

The scene description may indicate a transformation of the scene coordinate system into the anchor XR space. For example, rotation, translation, and scaling of the origin of the scene description coordinate space may be performed to align to the XR space. In the absence of any transform, the coordinate system of the scene description is aligned with that of the anchor space.

XR runtime systems, such as OpenXR, allow querying of the bounding space for an XR space. The scene description may request that the presentation engine aligns the scene extents, i.e. the bounding box of the scene, to the bounding box of the anchor XR space. The scene description may indicate if this alignment involves scaling to match the two spaces or not. The scaling may be in both dimensions, or the scaling may conserve the spatial extent relationships of the scene. If no scaling is applied, the presentation engine aligns the long edge of the scene bounding box to that of the XR space and then centers the scene bounding box to be collocated with the center of the XR space bounding box.

In the example of FIG. 9, the anchor XR space is of type “stage,” corresponding to the floor of the viewer's living room.

According to the techniques of this disclosure, an MPEG_scene_anchor extension may be added as a glTF 2.0 extension to the scene node. An AR scene may contain the MPEG_scene_anchor extension to describe the anchoring of the scene to a real-world XR space. The extension may be declared in the extensionsUsed element and may be included in the extensionsRequired element of the glTF 2.0 scene.

When a presentation engine, e.g., executed by client device 40 of FIG. 1, does not support the scene anchor extension, the presentation engine may revert to rendering a complete virtual scene.

Table 1 below represents an example set of elements of an MPEG_scene_anchor extension and their properties:

TABLE 1

| Name | Type | Default | Description |
|---|---|---|---|
| xrReferenceSpace | enumeration | STAGE | the reference type may be one of |
| Type | | | VIEW=1, LOCAL=2, STAGE=3, or |
| | | | APPLICATION=4. |
| aligned | enumeration | NOT_ALIGNED | the aligned flag may take one of the |
| | | | following values: NOT_ALIGNED=0, |
| | | | ALIGNED_NOTSCALED=1, |
| | | | ALIGNED_SCALED=2. |
| | | | If ALIGNED_SCALED is set, the |
| | | | scene bounding box is aligned to the |
| | | | bounding box of the XR space. |
| if | | | |
| (aligned==NOT_{—} | | | |
| ALIGNED) { | | | |
| transformation | matrix4x4 | N/A | a transformation of the scene space to |
| | | | anchor it to the XR space. |
| position | array(number) | | position of the origin of the scene |
| | | | coordinate system in the XR space. |
| orientation | array(number) | | Quaternion describing the rotation of |
| | | | the scene in the anchor space. |
| | | | centerPosition and orientation are used |
| | | | as alternatives to transformation. |
| } | | | |
| if (xrReference | | | |
| Type== | | | |
| APPLICATION) | | | |
| { | | | |
| xrActionSpace | string | | An application defined Action Space, |
| | | | e.g. that corresponds to controller |
| | | | actions. The XRAction to be used as |
| | | | anchor is identified by the path, e.g. |
| | | | “input/thumbstick/right” |
| xrObjectId | number | | identifier shared between application |
| | | | and content server. The client may |
| | | | send a list of applications to the server |
| | | | or it may send a media streams to the |
| | | | server for object detection and then |
| | | | gets a list of identified objects and |
| | | | their locations. The shared objects |
| | | | may be used as anchor points. An XR |
| | | | Space may be created for anchor |
| | | | objects to track them in space. |
| } | | | |
| poseFeedback | number | | accessor that describes an uplink |
| | | | stream to which pose information is to |
| | | | be sent. |
| sceneUnderstandingStream | number | | accessor that describes an uplink |
| | | | stream to which the local captured |
| | | | view is to be streamed. |

The following set of data represents an example instance of the scene anchor extension described above:

```
{
  “scene”: 0,
  “scenes”: [
    {
      “extensions”: {
        “MPEG_scene_anchor”: {
          “xrReferenceSpaceType”: 4, # Application
          “aligned” : 0, # NOT_ALIGNED
          “xrActionSpace” : “/user/hand/right/input/grip”,
          “sceneUnderstandingStream”: 15
        }
      },
      “name”: “Scene”,
      “nodes”: [
        759,
        760,
        761,
        762,
        763,
        764
      ]
    }
  ]
}
```

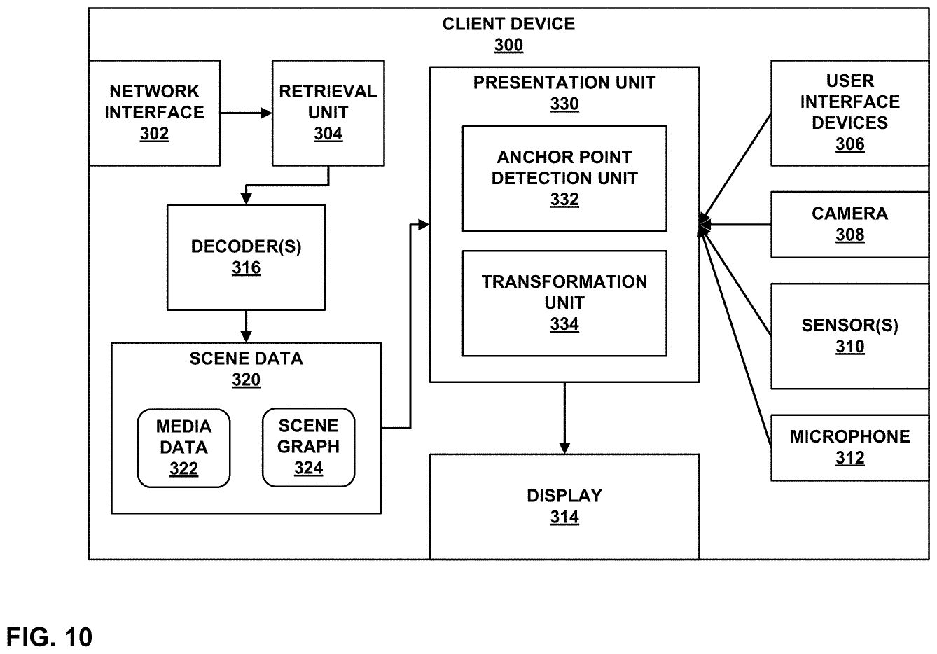

FIG. 10 is a block diagram illustrating another example client device 300 that may perform the techniques of this disclosure. Client device 300 may correspond to client device 40 of FIG. 1. In this example, client device 300 includes network interface 302, retrieval unit 304, user interface devices 306, camera 308, sensors 310, microphone 312, display 314, decoders 316, scene data 320, and presentation engine 330. Any or all of the various units and devices may be implemented in software, hardware, or firmware. When implemented in software or firmware, it should be understood that requisite hardware, such as a memory for storing instructions and one or more processors for executing the instructions, may also be provided. Hardware may include one or more processing circuits, such as one or more digital signal processors (DSPs), general purpose microprocessors, application specific integrated circuits (ASIC s), field programmable logic arrays (FPGAs), or other equivalent integrated or discrete logic circuitry.

Network interface 302 is generally configured to send and receive data via a network. For example, network interface 302 may include a network interface card (NIC) configured to send and receive Ethernet data. Alternatively, network interface 302 may be a wireless network interface configured to send and receive network data according to any of a variety of protocols, such as any of the various IEEE 802.11 network protocols. Network interface 302 may correspond to network interface 54 of FIG. 1.

Retrieval unit 304 may correspond to retrieval unit 52 of FIGS. 1 and 2. Retrieval unit 304 may be configured to retrieve media data via network interface 302 according to a variety of retrieval protocols. For example, retrieval unit 304 may be configured to retrieve media data via unicast according to DASH. As another example, retrieval unit 304 may be configured to receive media data via broadcast or multicast, e.g., according to eMBMS. As yet another example, retrieval unit 304 may be configured to retrieve media data according to Real-time Transport Protocol (RTP). Other protocols for retrieving media data may also be used.

Decoders 316 may correspond to audio decoder 46 and video decoder 48 of FIG. 1. Additionally or alternatively, decoders 316 may correspond to decoders 212 of FIG. 6. In general, decoders 316 decode various types of media data, such as two-dimensional video, three-dimensional video, audio, metadata, or the like. Decoders 316 may output decoded media data to scene data 320.

Scene data 320 represents one or more memories (storage devices) for storing media data 322. Additionally, according to the techniques of this disclosure, scene data 320 also stores scene graph 324. Scene graph 324 may correspond to the scene graph of FIG. 5, scene description and updates 200 of FIG. 6, and/or scene graph 262 and scene graph updates 264 of FIG. 8. Scene graph 324 may be updated according to various inputs, such as when a user moves their head (as detected by camera 308 and/or sensors 310), when a user interacts with (e.g., makes contact with) a virtual object (as detected through collision in response to movement detected by camera 308, sensors 310, and/or user interface device 306), or through animations defined in scene graph 324.

Scene graph 324 also includes at least one scene anchor, according to the techniques of this disclosure. The scene anchor may be a reference space in a real-world presentation environment, e.g., local, view, or stage. According to the OpenXR specification, a view space tracks view origin used to generate view transforms for the primary viewer (user) with up/down, left/right, and forward/backward movements. A local space establishes a world-locked origin, gravity-aligned to exclude pitch and roll, with up/down, left/right, and forward/backward movements. A stage space is a runtime-defined flat, rectangular space that is empty and can be walked around on, having an origin on the floor at the center of the rectangle, with up/down, left/right, and forward/backward movements aligned to axes of the stage.

Thus, view space may be used for virtual objects that are to be persistently presented on the display regardless of user viewport direction and orientation, such as reticules, heads-up displays (HUDs), or the like. The local space may be used for virtual objects that are not positioned relative to the physical floor of the real-world presentation environment. The stage space may be used for other virtual objects that a user may interact with and that may be positioned relative to the physical floor (stage) of the real-world presentation environment.

User interface devices 306 may include controllers or other devices by which a user provides input to client device 300. Such controllers may include one or more buttons, track pads, analog control sticks, analog triggers, or the like. Using these various elements of user input devices 306, a user may provide input representing virtual world movement, interaction with virtual objects (e.g., opening a door or chest), opening a menu, or the like.

Camera 308 represents a camera used to capture images or video data of the real-world presentation environment. In some examples, camera 308 may detect light emitted from devices coupled to client device 300, such as infrared light boxes, which may be used to determine the location and orientation of a user in the real-world presentation environment. Additionally or alternatively, camera 308 may detect real-world objects, such as the floor, the ceiling, walls, chairs, tables, or the like, and client device 300 may provide a warning to the user of potential collision with the real-world objects. Similarly, sensors 310 may be gyroscopes and/or other sensors for detecting posture, location, and/or orientation information of a user in the real-world presentation environment. Microphone 312 may be a microphone for capturing speech of the user, e.g., to be transmitted to other users when multiple people are interacting with a virtual environment, e.g., for a virtual presentation or game.

Display 314 represents a display for providing visual output to the user. Display 314 may include two screens for providing separate output to the user's eyes, e.g., a left-eye screen and a right-eye screen. Alternatively, display 314 may include a single display that is configured to rapidly alternate between left-eye and right-eye presentations, and the user's eyes may be alternately shuttered in a synchronized fashion with the display.

Presentation unit 330 in this example includes anchor point detection unit 332 and transformation unit 334. Presentation unit 330 may receive data from scene graph 324 to determine an anchor point type, e.g., local, view, or stage. Presentation unit 330 may also receive image input from camera 308 and sensor data from sensors 310. Anchor point detection unit 332 may determine a type of anchor point to be used from the data of scene graph 324, and identify a corresponding real-world anchor point using image data from camera 308. Presentation unit 330 may use the identified anchor point in the real-world presentation environment to align a virtual scene with the real-world presentation environment. For example, the real-world anchor point may be a point on the floor, a surface (e.g., a table), or the like. In some examples, a visual marker on the real-world object may be used, such as a quick response (QR) code, to represent the real-world anchor point.

In some examples, presentation unit 330 may receive data from an application (not shown) executed by client device 300 representing an application-defined space, corresponding to the real-world presentation environment. For example, a user may use user interface devices 306 to define the application-defined space. Presentation unit 330 may receive data from the application representing the application-defined space. The application-defined space may include the real-world anchor point.

Transformation unit 334 may transform the virtual scene to match the real-world presentation environment. For example, transformation unit 334 may determine an orientation of the virtual scene and an orientation of the real-world presentation environment, then transform the virtual scene such that the orientations of the virtual scene and the real-world presentation environment are aligned. That is, scene graph 324 may include data representing a transformation of a scene coordinate system into a real-world coordinate system of the real-world presentation environment. Such transformation may include a rotation and/or translation. Additionally or alternatively, transformation unit 334 may grow or shrink the virtual scene to fit within the real-world presentation environment according to a scaling transformation.

After aligning the virtual scene anchor point with the real-world anchor point and making any necessary transformations, presentation unit 330 may present media data 322 via display 314. For example, media data 322 may include data defining virtual objects, textures, colors, and locations for the virtual objects. Presentation unit 330 may present the virtual objects at the corresponding locations, relative to the user's virtual camera orientation (determined from data received from camera 308 and sensors 310). Presentation unit 330 may update the presentation according to user movements detected from user interface devices 306, camera 308, and/or sensors 310, and/or based on updated to scene graph 324.

For example, a user may interact with a virtual object, e.g., by colliding with the virtual object or by pressing a button to interact with the virtual object. Presentation unit 330 may determine an animation to render on the virtual object in response to such action, e.g., movement, rotation, deformation, or the like of the virtual object. Such animations may be defined in, e.g., animation node 184 of the example scene graph of FIG. 5. Thus, in subsequently outputted frames, presentation unit 330 may update the location and orientation of the virtual object, relative to a user's perspective as determined by data received from camera 308 and sensors 310. Such updates may further include modifications to the presentation of the virtual objects based on locations of light sources, and the texture and color information for the virtual objects.

In some examples, scene graph 324 may include data for the MPEG_scene_anchor discussed above with respect to Table 1. As shown in Table 1, the MPEG_scene_anchor may include a poseFeedback element and a sceneUnderstandingStream element. When a user's pose changes, as detected by camera 308 and sensors 310, client device 300 may send pose information updates via an uplink stream indicated by the poseFeedback element using network interface using network interface 302. If a locally captured view, captured by 308, is to be uploaded, client device 300 may send the locally captured view via an uplink stream indicated by the sceneUnderstandingStream element using network interface 302.

In this manner, client device 300 represents an example of a device for presenting media including a memory configured to store media data defining one or more virtual objects in a virtual scene; and one or more processors implemented in circuitry and configured to: receive a scene description of a bitstream including the data describing the one or more virtual objects in the virtual scene and a scene anchor, the scene anchor representing a correspondence between the virtual scene and a real-world presentation environment; determine the correspondence between the virtual scene and the real-world presentation environment using the scene anchor; and present the one or more virtual objects at locations within the real-world presentation environment according to the determined correspondence.

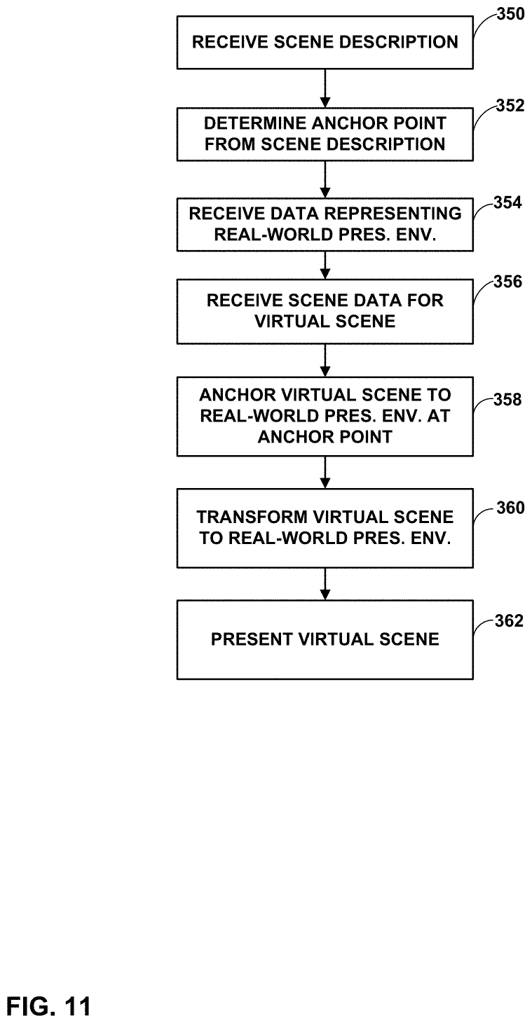

FIG. 11 is a flowchart illustrating an example method according to the techniques of this disclosure. The method of FIG. 11 may be performed by, e.g., client device 40 of FIG. 1, a device or set of devices conforming to the MPEG-I architecture of FIG. 6 or FIG. 8, or client device 300 of FIG. 10. For purposes of example and explanation, the method of FIG. 11 is described with respect to client device 300 of FIG. 10. However, it should be understood that other devices or sets of devices may be configured to perform this or a similar method.

Initially, client device 300 may receive a bitstream including a scene description (350). For example, client device 300 may retrieve the bitstream according to DASH, RTP, eMBMS, or other unicast, broadcast, or multicast, network protocols. That is, receiving the scene description may include any method for obtaining the scene description, such as wireless or wired transmission and reception over a network, from a computer-readable medium such as a transmission medium or a storage medium such as a CD ROM, DVD, Blu-Ray disc, a storage device such as a hard drive or flash drive, or the like. The bitstream may further include media data for one or more virtual objects, such as walls, ceiling, floor, doors, tables, chairs, or the like. The scene description may include a scene graph that is periodically updated by scene graph updates. For example, the scene description may correspond to the example scene graph of FIG. 5, scene description and updates 200 of FIG. 6, scene graph 262 and scene graph updates 264 of FIG. 8, or scene graph 324 of FIG. 10.

Presentation unit 330 of client device 300 may determine an anchor point from the scene description (352). According to the techniques of this disclosure, the scene description may include data for an anchor point, such as the MPEG_scene_anchor as discussed above with respect to Table 1. The data for the anchor point may include, for example, data indicating whether the reference space type (e.g., a real-world presentation environment) is to be a view, local, stage, or application type of reference space. The data for the anchor point may further indicate whether the scene data is to be transformed (e.g., rotated, translated, and/or scaled) to match the real-world presentation environment. The anchor point may further include various actions that a user may perform, such as movements received via a controller or real-world repositioning of a device worn by the user. The anchor point may also include object identifiers that are shared between a presentation application and the server. Such objects may be used as anchor points. In general, the scene description may include data that relates the scene anchor point to a real-world anchor point, such as a particular location on the floor (e.g., a midpoint of the floor).

Presentation unit 330 may also receive data representing the real-world presentation environment (354). In some examples, this data may be provided by an application that receives input data from the user. For example, the user may use user interface devices 306 to define the real-world presentation environment, e.g., by tracing the real-world presentation environment physically or virtually with user interface devices 302. In some examples, presentation unit 330 may automatically detect the real-world presentation environment using camera 308. In some examples, client device 300 may receive image and/or video data captured by camera 308 and upload this data via a sceneUnderstandingStream as indicated by the scene description, then receive data via network interface 302 indicating a position of the real-world anchor point in the real-world presentation environment.

Presentation unit 330 may then receive data for the virtual scene (356). For example, the bitstream may include data for one or more virtual objects, including data defining the objects themselves, locations of the objects within the virtual scene, textures for the objects, and colors for the objects. Presentation unit 330 may anchor the virtual scene to the real-world presentation environment at the determined real-world anchor point (358). Presentation unit 330 may also transform the virtual scene to align with the real-world presentation environment (360), e.g., using rotation, translation, and/or scaling. Presentation unit 330 may then present the virtual scene (362), including presenting the virtual objects at appropriate positions within the virtual scene.

The user may move a virtual camera (representing the user's eyes) through the virtual scene using user interface devices 306 or physical movement, which may be detected by camera 308 and/or sensors 310. In response to such movements, presentation unit 330 may update the presentation to account for the new virtual camera location. For example, for “view” anchored objects, the position may remain unchanged, but for “local” or “stage” anchored objects, the positions may change based on user movement or virtual object animations.

In this manner, the method of FIG. 11 represents an example of a method including receiving a scene description of a bitstream, the scene description including data describing a scene anchor and one or more virtual objects in a virtual scene, the scene anchor representing a correspondence between the virtual scene and a real-world presentation environment; determining the correspondence between the virtual scene and the real-world presentation environment using the scene anchor; and presenting the one or more virtual objects at locations within the real-world presentation environment according to the determined correspondence.

Various examples of the techniques of this disclosure are summarized in the following clauses:

Clause 1: A method of presenting media data, the method comprising: receiving a scene description of a bitstream including data describing one or more virtual objects in a virtual scene and a scene anchor, the scene anchor representing a correspondence between the virtual scene and a real-world presentation environment; determining the correspondence between the virtual scene and the real-world presentation environment; and presenting the one or more virtual objects at locations within the real-world presentation environment according to the determined correspondence.

Clause 2: The method of clause 1, wherein the scene anchor includes data defining a type for the real-world presentation environment, the type being one or more of local, view, or stage.

Clause 3: The method of clause 1, wherein the scene anchor includes data defining a type for the real-world presentation environment, the type being an application-defined space, the method further comprising receiving data defining the application-defined space.

Clause 4: The method of any of clauses 1-3, wherein the scene description includes data representing a transformation of a scene coordinate system into a coordinate system of the real-world presentation environment.

Clause 5: The method of clause 4, wherein the transformation includes one or more of a rotation, a translation, or scaling.

Clause 6: The method of any of clauses 1-5, wherein presenting the one or more virtual objects comprises aligning the virtual scene to the real-world presentation environment.

Clause 7: The method of clause 1, wherein the scene anchor includes data defining a type for the real-world presentation environment, the type being one or more of local, view, or stage.

Clause 8: The method of clause 1, wherein the scene anchor includes data defining a type for the real-world presentation environment, the type being an application-defined space, the method further comprising receiving data defining the application-defined space.

Clause 9: The method of clause 1, wherein the scene description includes data representing a transformation of a scene coordinate system into a coordinate system of the real-world presentation environment.

Clause 10: The method of clause 9, wherein the transformation includes one or more of a rotation, a translation, or scaling.

Clause 11: The method of clause 1, wherein presenting the one or more virtual objects comprises aligning the virtual scene to the real-world presentation environment.

Clause 12: A device for presenting media data, the device comprising one or means for performing the method of any of clauses 1-11.

Clause 13: The device of clause 12, wherein the one or more means comprise one or more processors implemented in circuitry.

Clause 14: The device of clause 12, further comprising a memory configured to store data of the bitstream.

Clause 15: The device of clause 12, wherein the device comprises at least one of: an integrated circuit; a microprocessor; and a wireless communication device.

Clause 16: A device for retrieving media data, the device comprising: means for receiving a scene description of a bitstream including data describing one or more virtual objects in a virtual scene and a scene anchor, the scene anchor representing a correspondence between the virtual scene and a real-world presentation environment; means for determining the correspondence between the virtual scene and the real-world presentation environment; and means for presenting the one or more virtual objects at locations within the real-world presentation environment according to the determined correspondence.

Clause 17: A method of presenting media data, the method comprising: receiving a scene description of a bitstream, the scene description including data describing a scene anchor and one or more virtual objects in a virtual scene, the scene anchor representing a correspondence between the virtual scene and a real-world presentation environment; determining the correspondence between the virtual scene and the real-world presentation environment using the scene anchor; and presenting the one or more virtual objects at locations within the real-world presentation environment according to the determined correspondence.

Clause 18: The method of clause 17, wherein the scene anchor includes data defining a type for the real-world presentation environment, the type being one or more of local, view, or stage.

Clause 19: The method of clause 17, wherein the scene anchor includes data defining a type for the real-world presentation environment, the type being an application-defined space, the method further comprising receiving data defining the application-defined space.

Clause 20: The method of clause 17, wherein the scene description includes data representing a transformation of a scene coordinate system into a coordinate system of the real-world presentation environment.

Clause 21: The method of clause 20, wherein the transformation includes one or more of a rotation, a translation, or scaling.

Clause 22: The method of clause 20, wherein presenting the one or more virtual objects comprises: determining signaled locations for the one or more virtual objects in the virtual scene; and transforming the signaled locations to real-world locations according to the transformation to produce the locations within the real-world presentation environment.

Clause 23: The method of clause 17, wherein presenting the one or more virtual objects comprises aligning the virtual scene to the real-world presentation environment according to the scene anchor.

Clause 24: The method of clause 17, wherein the scene description further includes data defining an action representing input received from a user, the method further comprising determining a modification to the location of at least one the one or more virtual objects or a virtual camera in response to the action, and wherein presenting the one or more virtual objects comprises presenting the one or more virtual objects according to the modification of the location of the at least one of the one or more virtual objects or the virtual camera.

Clause 25: The method of clause 17, wherein the scene description further includes data defining object identifiers for the one or more virtual objects.

Clause 26: A device for presenting media data, the device comprising: a memory configured to store media data defining one or more virtual objects in a virtual scene; and one or more processors implemented in circuitry and configured to: receive a scene description of a bitstream, the scene description including data describing a scene anchor and one or more virtual objects in a virtual scene, the scene anchor representing a correspondence between the virtual scene and a real-world presentation environment; determine the correspondence between the virtual scene and the real-world presentation environment using the scene anchor; and present the one or more virtual objects at locations within the real-world presentation environment according to the determined correspondence.

Clause 27: The device of clause 26, wherein the scene anchor includes data defining a type for the real-world presentation environment, the type being one or more of local, view, or stage.

Clause 28: The device of clause 26, wherein the scene anchor includes data defining a type for the real-world presentation environment, the type being an application-defined space, the method further comprising receiving data defining the application-defined space.

Clause 29: The device of clause 26, wherein the scene description includes data representing a transformation of a scene coordinate system into a coordinate system of the real-world presentation environment.

Clause 30: The device of clause 29, wherein the transformation includes one or more of a rotation, a translation, or scaling.

Clause 31: The device of clause 29, wherein to present the one or more virtual objects, the one or more processors are configured to: determine signaled locations for the one or more virtual objects in the virtual scene; and transform the signaled locations to real-world locations according to the transformation to produce the locations within the real-world presentation environment.

Clause 32: The device of clause 26, wherein to present the one or more virtual objects, the one or more processors are configured to align the virtual scene to the real-world presentation environment according to the scene anchor.

Clause 33: The device of clause 26, wherein the scene description further includes data defining an action representing input received from a user, and wherein the one or more processors are further configured to determine a modification to the location of at least one the one or more virtual objects or a virtual camera in response to the action, and wherein the one or more processors are configured to present the one or more virtual objects according to the modification of the location of the at least one of the one or more virtual objects or the virtual camera.

Clause 34: The device of clause 26, wherein the scene description further includes data defining object identifiers for the one or more virtual objects.

Clause 35: The device of clause 26, wherein the device comprises at least one of: an integrated circuit; a microprocessor; and a wireless communication device.

Clause 36: A computer-readable storage medium having stored thereon instructions that, when executed, cause a processor to: receive a scene description of a bitstream, the scene description including data describing a scene anchor and one or more virtual objects in a virtual scene, the scene anchor representing a correspondence between the virtual scene and a real-world presentation environment; determine the correspondence between the virtual scene and the real-world presentation environment using the scene anchor; and present the one or more virtual objects at locations within the real-world presentation environment according to the determined correspondence.

Clause 37: The computer-readable storage medium of clause 36, wherein the scene anchor includes data defining a type for the real-world presentation environment, the type being one or more of local, view, or stage.

Clause 38: The computer-readable storage medium of clause 36, wherein the scene anchor includes data defining a type for the real-world presentation environment, the type being an application-defined space, the method further comprising receiving data defining the application-defined space.

Clause 39: The computer-readable storage medium of clause 36, wherein the scene description includes data representing a transformation of a scene coordinate system into a coordinate system of the real-world presentation environment.

Clause 40: The computer-readable storage medium of clause 39, wherein the transformation includes one or more of a rotation, a translation, or scaling.

Clause 41: The computer-readable storage medium of clause 39, wherein the instructions that cause the processor to present the one or more virtual objects comprise instructions that cause the processor to: determine signaled locations for the one or more virtual objects in the virtual scene; and transform the signaled locations to real-world locations according to the transformation to produce the locations within the real-world presentation environment.

Clause 42: The computer-readable storage medium of clause 36, wherein the instructions that cause the processor to present the one or more virtual objects comprise instructions that cause the processor to align the virtual scene to the real-world presentation environment according to the scene anchor.

Clause 43: The computer-readable storage medium of clause 36, wherein the scene description further includes data defining an action representing input received from a user, further comprising instructions that cause the processor to determine a modification to the location of at least one the one or more virtual objects or a virtual camera in response to the action, and wherein the instructions that cause the processor to present the one or more virtual objects comprise instructions that cause the processor to present the one or more virtual objects according to the modification of the location of the at least one of the one or more virtual objects or the virtual camera.

Clause 44: The computer-readable storage medium of clause 36, wherein the scene description further includes data defining object identifiers for the one or more virtual objects.

Clause 45: A device for presenting media data, the device comprising: means for receiving a scene description of a bitstream, the scene description including data describing a scene anchor and one or more virtual objects in a virtual scene, the scene anchor representing a correspondence between the virtual scene and a real-world presentation environment; means for determining the correspondence between the virtual scene and the real-world presentation environment using the scene anchor; and means for presenting the one or more virtual objects at locations within the real-world presentation environment according to the determined correspondence.

Clause 46: The device of clause 45, wherein the scene anchor includes data defining a type for the real-world presentation environment, the type being one or more of local, view, or stage.

Clause 47: The device of clause 45, wherein the scene anchor includes data defining a type for the real-world presentation environment, the type being an application-defined space, the method further comprising receiving data defining the application-defined space.

Clause 48: The device of clause 45, wherein the scene description includes data representing a transformation of a scene coordinate system into a coordinate system of the real-world presentation environment.

Clause 49: The device of clause 48, wherein the transformation includes one or more of a rotation, a translation, or scaling.

Clause 50: The device of clause 48, wherein the means for presenting the one or more virtual objects comprises: means for determining signaled locations for the one or more virtual objects in the virtual scene; and means for transforming the signaled locations to real-world locations according to the transformation to produce the locations within the real-world presentation environment.

Clause 51: The device of clause 45, wherein the means for presenting the one or more virtual objects comprises means for aligning the virtual scene to the real-world presentation environment according to the scene anchor.

Clause 52: The device of clause 45, wherein the scene description further includes data defining an action representing input received from a user, further comprising means for determining a modification to the location of at least one the one or more virtual objects or a virtual camera in response to the action, and wherein the means for presenting the one or more virtual objects comprises means for presenting the one or more virtual objects according to the modification of the location of the at least one of the one or more virtual objects or the virtual camera.

Clause 53: The device of clause 45, wherein the scene description further includes data defining object identifiers for the one or more virtual objects.

Clause 54: A method of presenting media data, the method comprising: receiving a scene description of a bitstream, the scene description including data describing a scene anchor and one or more virtual objects in a virtual scene, the scene anchor representing a correspondence between the virtual scene and a real-world presentation environment; determining the correspondence between the virtual scene and the real-world presentation environment using the scene anchor; and presenting the one or more virtual objects at locations within the real-world presentation environment according to the determined correspondence.

Clause 55: The method of clause 54, wherein the scene anchor includes data defining a type for the real-world presentation environment, the type being one or more of local, view, or stage.

Clause 56: The method of any of clauses 54 and 55, wherein the scene anchor includes data defining a type for the real-world presentation environment, the type being an application-defined space, the method further comprising receiving data defining the application-defined space.

Clause 57: The method of any of clauses 54-56, wherein the scene description includes data representing a transformation of a scene coordinate system into a coordinate system of the real-world presentation environment.

Clause 58: The method of clause 57, wherein the transformation includes one or more of a rotation, a translation, or scaling.

Clause 59: The method of any of clauses 57 and 58, wherein presenting the one or more virtual objects comprises: determining signaled locations for the one or more virtual objects in the virtual scene; and transforming the signaled locations to real-world locations according to the transformation to produce the locations within the real-world presentation environment.

Clause 60: The method of any of clauses 54-59, wherein presenting the one or more virtual objects comprises aligning the virtual scene to the real-world presentation environment according to the scene anchor.

Clause 61: The method of any of clauses 54-60, wherein the scene description further includes data defining an action representing input received from a user, the method further comprising determining a modification to the location of at least one the one or more virtual objects or a virtual camera in response to the action, and wherein presenting the one or more virtual objects comprises presenting the one or more virtual objects according to the modification of the location of the at least one of the one or more virtual objects or the virtual camera.

Clause 62: The method of any of clauses 54-61, wherein the scene description further includes data defining object identifiers for the one or more virtual objects.

Clause 63: A device for presenting media data, the device comprising: a memory configured to store media data defining one or more virtual objects in a virtual scene; and one or more processors implemented in circuitry and configured to: receive a scene description of a bitstream, the scene description including data describing a scene anchor and one or more virtual objects in a virtual scene, the scene anchor representing a correspondence between the virtual scene and a real-world presentation environment; determine the correspondence between the virtual scene and the real-world presentation environment using the scene anchor; and present the one or more virtual objects at locations within the real-world presentation environment according to the determined correspondence.

Clause 64: The device of clause 63, wherein the scene anchor includes data defining a type for the real-world presentation environment, the type being one or more of local, view, or stage.

Clause 65: The device of any of clauses 63 and 64, wherein the scene anchor includes data defining a type for the real-world presentation environment, the type being an application-defined space, the method further comprising receiving data defining the application-defined space.

Clause 66: The device of any of clauses 63-65, wherein the scene description includes data representing a transformation of a scene coordinate system into a coordinate system of the real-world presentation environment.

Clause 67: The device of clause 66, wherein the transformation includes one or more of a rotation, a translation, or scaling.

Clause 68: The device of any of clauses 66 and 67, wherein to present the one or more virtual objects, the one or more processors are configured to: determine signaled locations for the one or more virtual objects in the virtual scene; and transform the signaled locations to real-world locations according to the transformation to produce the locations within the real-world presentation environment.

Clause 69: The device of any of clauses 63-68, wherein to present the one or more virtual objects, the one or more processors are configured to align the virtual scene to the real-world presentation environment according to the scene anchor.

Clause 70: The device of any of clauses 63-69, wherein the scene description further includes data defining an action representing input received from a user, and wherein the one or more processors are further configured to determine a modification to the location of at least one the one or more virtual objects or a virtual camera in response to the action, and wherein the one or more processors are configured to present the one or more virtual objects according to the modification of the location of the at least one of the one or more virtual objects or the virtual camera.

Clause 71: The device of any of clauses 63-70, wherein the scene description further includes data defining object identifiers for the one or more virtual objects.

Clause 72: The device of any of clauses 63-71, wherein the device comprises at least one of: an integrated circuit; a microprocessor; and a wireless communication device.

Clause 73: A computer-readable storage medium having stored thereon instructions that, when executed, cause a processor to: receive a scene description of a bitstream, the scene description including data describing a scene anchor and one or more virtual objects in a virtual scene, the scene anchor representing a correspondence between the virtual scene and a real-world presentation environment; determine the correspondence between the virtual scene and the real-world presentation environment using the scene anchor; and present the one or more virtual objects at locations within the real-world presentation environment according to the determined correspondence.

Clause 74: The computer-readable storage medium of clause 73, wherein the scene anchor includes data defining a type for the real-world presentation environment, the type being one or more of local, view, or stage.

Clause 75: The computer-readable storage medium of any of clauses 73 and 74, wherein the scene anchor includes data defining a type for the real-world presentation environment, the type being an application-defined space, the method further comprising receiving data defining the application-defined space.

Clause 76: The computer-readable storage medium of any of clauses 73-75, wherein the scene description includes data representing a transformation of a scene coordinate system into a coordinate system of the real-world presentation environment.

Clause 77: The computer-readable storage medium of clause 76, wherein the transformation includes one or more of a rotation, a translation, or scaling.

Clause 78: The computer-readable storage medium of any of clauses 76 and 77, wherein the instructions that cause the processor to present the one or more virtual objects comprise instructions that cause the processor to: determine signaled locations for the one or more virtual objects in the virtual scene; and transform the signaled locations to real-world locations according to the transformation to produce the locations within the real-world presentation environment.

Clause 79: The computer-readable storage medium of any of clauses 73-78, wherein the instructions that cause the processor to present the one or more virtual objects comprise instructions that cause the processor to align the virtual scene to the real-world presentation environment according to the scene anchor.

Clause 80: The computer-readable storage medium of any of clauses 73-79, wherein the scene description further includes data defining an action representing input received from a user, further comprising instructions that cause the processor to determine a modification to the location of at least one the one or more virtual objects or a virtual camera in response to the action, and wherein the instructions that cause the processor to present the one or more virtual objects comprise instructions that cause the processor to present the one or more virtual objects according to the modification of the location of the at least one of the one or more virtual objects or the virtual camera.

Clause 81: The computer-readable storage medium of any of clauses 73-80, wherein the scene description further includes data defining object identifiers for the one or more virtual objects.

Clause 82: A device for presenting media data, the device comprising: means for receiving a scene description of a bitstream, the scene description including data describing a scene anchor and one or more virtual objects in a virtual scene, the scene anchor representing a correspondence between the virtual scene and a real-world presentation environment; means for determining the correspondence between the virtual scene and the real-world presentation environment using the scene anchor; and means for presenting the one or more virtual objects at locations within the real-world presentation environment according to the determined correspondence.

Clause 83: The device of clause 82, wherein the scene anchor includes data defining a type for the real-world presentation environment, the type being one or more of local, view, or stage.

Clause 84: The device of any of clauses 82 and 83, wherein the scene anchor includes data defining a type for the real-world presentation environment, the type being an application-defined space, the method further comprising receiving data defining the application-defined space.

Clause 85: The device of any of clauses 82-84, wherein the scene description includes data representing a transformation of a scene coordinate system into a coordinate system of the real-world presentation environment.

Clause 86: The device of clause 85, wherein the transformation includes one or more of a rotation, a translation, or scaling.

Clause 87: The device of any of clauses 85 and 86, wherein the means for presenting the one or more virtual objects comprises: means for determining signaled locations for the one or more virtual objects in the virtual scene; and means for transforming the signaled locations to real-world locations according to the transformation to produce the locations within the real-world presentation environment.

Clause 88: The device of any of clauses 82-87, wherein the means for presenting the one or more virtual objects comprises means for aligning the virtual scene to the real-world presentation environment according to the scene anchor.

Clause 89: The device of any of clauses 82-88, wherein the scene description further includes data defining an action representing input received from a user, further comprising means for determining a modification to the location of at least one the one or more virtual objects or a virtual camera in response to the action, and wherein the means for presenting the one or more virtual objects comprises means for presenting the one or more virtual objects according to the modification of the location of the at least one of the one or more virtual objects or the virtual camera.

Clause 90: The device of any of clauses 82-89, wherein the scene description further includes data defining object identifiers for the one or more virtual objects.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of presenting media data, the method comprising:
receiving a scene description of a bitstream, the scene description including data describing a scene anchor and one or more virtual objects in a virtual scene, the scene anchor representing a correspondence between the virtual scene and a real-world presentation environment;
determining the correspondence between the virtual scene and the real-world presentation environment using the scene anchor; and
presenting the one or more virtual objects at locations within the real-world presentation environment according to the determined correspondence.

2. The method of claim 1, wherein the scene anchor includes data defining a type for the real-world presentation environment, the type being one or more of local, view, or stage.

3. The method of claim 1, wherein the scene anchor includes data defining a type for the real-world presentation environment, the type being an application-defined space, the method further comprising receiving data defining the application-defined space.

4. The method of claim 1, wherein the scene description includes data representing a transformation of a scene coordinate system into a coordinate system of the real-world presentation environment.

5. The method of claim 4, wherein the transformation includes one or more of a rotation, a translation, or scaling.

6. The method of claim 4, wherein presenting the one or more virtual objects comprises:
determining signaled locations for the one or more virtual objects in the virtual scene; and
transforming the signaled locations to real-world locations according to the transformation to produce the locations within the real-world presentation environment.

7. The method of claim 1, wherein presenting the one or more virtual objects comprises aligning the virtual scene to the real-world presentation environment according to the scene anchor.

8. The method of claim 1, wherein the scene description further includes data defining an action representing input received from a user, the method further comprising determining a modification to the location of at least one the one or more virtual objects or a virtual camera in response to the action, and wherein presenting the one or more virtual objects comprises presenting the one or more virtual objects according to the modification of the location of the at least one of the one or more virtual objects or the virtual camera.

9. The method of claim 1, wherein the scene description further includes data defining object identifiers for the one or more virtual objects.

10. A device for presenting media data, the device comprising:
a memory configured to store media data defining one or more virtual objects in a virtual scene; and
one or more processors implemented in circuitry and configured to:
receive a scene description of a bitstream, the scene description including data describing a scene anchor and one or more virtual objects in a virtual scene, the scene anchor representing a correspondence between the virtual scene and a real-world presentation environment;
determine the correspondence between the virtual scene and the real-world presentation environment using the scene anchor; and
present the one or more virtual objects at locations within the real-world presentation environment according to the determined correspondence.

11. The device of claim 10, wherein the scene anchor includes data defining a type for the real-world presentation environment, the type being one or more of local, view, or stage.

12. The device of claim 10, wherein the scene anchor includes data defining a type for the real-world presentation environment, the type being an application-defined space, the method further comprising receiving data defining the application-defined space.

13. The device of claim 10, wherein the scene description includes data representing a transformation of a scene coordinate system into a coordinate system of the real-world presentation environment.

14. The device of claim 13, wherein the transformation includes one or more of a rotation, a translation, or scaling.

15. The device of claim 13, wherein to present the one or more virtual objects, the one or more processors are configured to:
determine signaled locations for the one or more virtual objects in the virtual scene; and
transform the signaled locations to real-world locations according to the transformation to produce the locations within the real-world presentation environment.

16. The device of claim 10, wherein to present the one or more virtual objects, the one or more processors are configured to align the virtual scene to the real-world presentation environment according to the scene anchor.

17. The device of claim 10, wherein the scene description further includes data defining an action representing input received from a user, and wherein the one or more processors are further configured to determine a modification to the location of at least one the one or more virtual objects or a virtual camera in response to the action, and wherein the one or more processors are configured to present the one or more virtual objects according to the modification of the location of the at least one of the one or more virtual objects or the virtual camera.

18. The device of claim 10, wherein the scene description further includes data defining object identifiers for the one or more virtual objects.

19. The device of claim 10, wherein the device comprises at least one of:
an integrated circuit;
a microprocessor; and
a wireless communication device.

20. A computer-readable storage medium having stored thereon instructions that, when executed, cause a processor to:
receive a scene description of a bitstream, the scene description including data describing a scene anchor and one or more virtual objects in a virtual scene, the scene anchor representing a correspondence between the virtual scene and a real-world presentation environment;
determine the correspondence between the virtual scene and the real-world presentation environment using the scene anchor; and
present the one or more virtual objects at locations within the real-world presentation environment according to the determined correspondence.

21. The computer-readable storage medium of claim 20, wherein the scene anchor includes data defining a type for the real-world presentation environment, the type being one or more of local, view, or stage.

22. The computer-readable storage medium of claim 20, wherein the scene anchor includes data defining a type for the real-world presentation environment, the type being an application-defined space, the method further comprising receiving data defining the application-defined space.

23. The computer-readable storage medium of claim 20, wherein the scene description includes data representing a transformation of a scene coordinate system into a coordinate system of the real-world presentation environment.

24. The computer-readable storage medium of claim 23, wherein the transformation includes one or more of a rotation, a translation, or scaling.

25. The computer-readable storage medium of claim 23, wherein the instructions that cause the processor to present the one or more virtual objects comprise instructions that cause the processor to:
determine signaled locations for the one or more virtual objects in the virtual scene; and
transform the signaled locations to real-world locations according to the transformation to produce the locations within the real-world presentation environment.

26. The computer-readable storage medium of claim 20, wherein the instructions that cause the processor to present the one or more virtual objects comprise instructions that cause the processor to align the virtual scene to the real-world presentation environment according to the scene anchor.

27. The computer-readable storage medium of claim 20, wherein the scene description further includes data defining an action representing input received from a user, further comprising instructions that cause the processor to determine a modification to the location of at least one the one or more virtual objects or a virtual camera in response to the action, and wherein the instructions that cause the processor to present the one or more virtual objects comprise instructions that cause the processor to present the one or more virtual objects according to the modification of the location of the at least one of the one or more virtual objects or the virtual camera.

28. The computer-readable storage medium of claim 20, wherein the scene description further includes data defining object identifiers for the one or more virtual objects.

29. A device for presenting media data, the device comprising:
means for receiving a scene description of a bitstream, the scene description including data describing a scene anchor and one or more virtual objects in a virtual scene, the scene anchor representing a correspondence between the virtual scene and a real-world presentation environment;
means for determining the correspondence between the virtual scene and the real-world presentation environment using the scene anchor; and
means for presenting the one or more virtual objects at locations within the real-world presentation environment according to the determined correspondence.

30. The device of claim 29, wherein the scene anchor includes data defining a type for the real-world presentation environment, the type being one or more of local, view, or stage.

31. The device of claim 29, wherein the scene anchor includes data defining a type for the real-world presentation environment, the type being an application-defined space, the method further comprising receiving data defining the application-defined space.

32. The device of claim 29, wherein the scene description includes data representing a transformation of a scene coordinate system into a coordinate system of the real-world presentation environment.

33. The device of claim 32, wherein the transformation includes one or more of a rotation, a translation, or scaling.

34. The device of claim 32, wherein the means for presenting the one or more virtual objects comprises:
means for determining signaled locations for the one or more virtual objects in the virtual scene; and
means for transforming the signaled locations to real-world locations according to the transformation to produce the locations within the real-world presentation environment.

35. The device of claim 29, wherein the means for presenting the one or more virtual objects comprises means for aligning the virtual scene to the real-world presentation environment according to the scene anchor.

36. The device of claim 29, wherein the scene description further includes data defining an action representing input received from a user, further comprising means for determining a modification to the location of at least one the one or more virtual objects or a virtual camera in response to the action, and wherein the means for presenting the one or more virtual objects comprises means for presenting the one or more virtual objects according to the modification of the location of the at least one of the one or more virtual objects or the virtual camera.

37. The device of claim 29, wherein the scene description further includes data defining object identifiers for the one or more virtual objects.
